(19) United States
(12) Patent Application Publication
(10) Pub. No.: US 2009/0113679 A1
(43) Pub. Date: May 7, 2009

(54) CASKET HARDWARE

(75) Inventors: Charles A. Malcomb, Hope, IN (US); James F. Tucker, New Palestine, IN (US)

Correspondence Address: WOOD, HERRON & EVANS, LLP, 2700 CAREW TOWER, 441 VINE STREET, CINCINNATI, OH, 45202, US

(73) Assignee: BATESVILLE SERVICES, INC., Batesville, IN (US)

(21) Appl. No.: 11/935,692

(22) Filed: Nov. 6, 2007

(51) Int. Cl. A61G 17/00

(52) U.S. Cl. 27/2

(57) ABSTRACT

A casket comprises a casket shell, a casket lid closeable on the shell, and casket hardware. The casket hardware comprises an arm having first and second ends, the first end attached to the shell. A handle bar is attached to the second end. The arm has a first structural load carrying portion for transmitting loads between the handle bar and the shell, and a second nonstructural decorative portion overlying the first portion.

### FIELD

This application relates generally to caskets, and more particularly to hardware for caskets.

### BACKGROUND

Caskets have traditionally been provided with hardware mounted peripherally around the shell of the casket for lifting and handling the casket. One form of casket hardware includes an arm with an elongated lifting handle bar attached to one end of the arm, with the other end of the arm being pivoted to a clevis with a rivet. The clevis has a bolt attached to it which passes through a hole in a decorative plate, known as an “ear” or “escutcheon,” and through a hole in the casket shell wall. A nut secures the bolt and hence arm and escutcheon plate to the shell wall. The escutcheon plate includes a recess or socket for receiving the clevis, and the arm generally includes an upper end which extends over the clevis. Thus once installed the casket hardware presents a decorative escutcheon plate from which depends a decorative arm which in turn supports the handle bar; the combination of arm and escutcheon recess hide from view the utilitarian mechanics of attaching the arm and escutcheon to the casket shell. Such casket hardware is disclosed in, for example, U.S. Pat. Nos. 3,204,286 and 4,615,085, both assigned to the assignee.

The arm has typically been cast from zinc. The arm casting molds have typically included decorative surface ornamentation that transfers to the casting which faces outwardly and is thus visible when the arm is mounted to the casket shell. However, the casting process limits the amount of detail which can be cast into the zinc arm, and so sharp detail in the surface ornamentation cannot be obtained. And, the zinc casting molds eventually over time wear out.

Accordingly, improvements in casket hardware, and particularly in casket hardware arms, are desired.

### SUMMARY

A casket comprises a casket shell, a casket lid closeable on the shell, and casket hardware. The casket hardware comprises an arm having first and second ends, the first end attached to the shell. A handle bar is attached to the second end. The arm has a first structural load carrying portion for transmitting loads between the handle bar and the shell, and a second nonstructural decorative portion overlying the first portion.

The second portion of the arm can be permanently or removably secured to the first portion of the arm. The first portion of the arm can be fabricated of steel and the second portion of the arm can be fabricated of plastic. The second portion of the arm can be a snap fit onto the first portion of the arm. The first end of the arm can be attached to the shell via a clevis. The first end of the arm can be pivotally secured to the clevis and the clevis can be fixedly secured to the shell. The arm can include a third portion which cooperates with the first portion to attach the handle bar to the arm. The first and third portions of the arm can be shaped to conform to the shape of the handle bar. The first portion of the arm can include a tongue on a lower end thereof, and the third portion of the arm can include a slot in a lower end thereof, the tongue fitting in the slot. The first portion of the arm can include a boss with an internally threaded hole therein, the third portion of the arm can include a hole in an upper end thereof, and a bolt can be passed through the hole in the third portion and threaded into the internally threaded hole in the boss in the first portion.

### DRAWINGS

FIG. 1 is a partial perspective view of a casket with hardware,

FIG. 2 is an exploded perspective view of the casket hardware, and

FIG. 3 is a back view of the second nonstructural decorative portion of the arm which overlies the first structural load carrying portion of the arm,

FIG. 4 is a back view of the assembled arm comprising the first structural load carrying portion and the second nonstructural decorative portion overlying the first structural portion,

FIG. 5 is a back view of the assembled arm comprising the first structural load carrying portion, second nonstructural decorative portion overlying the first structural portion, and third portion which cooperates with the first portion to attach the handle bar to the arm.

### DESCRIPTION

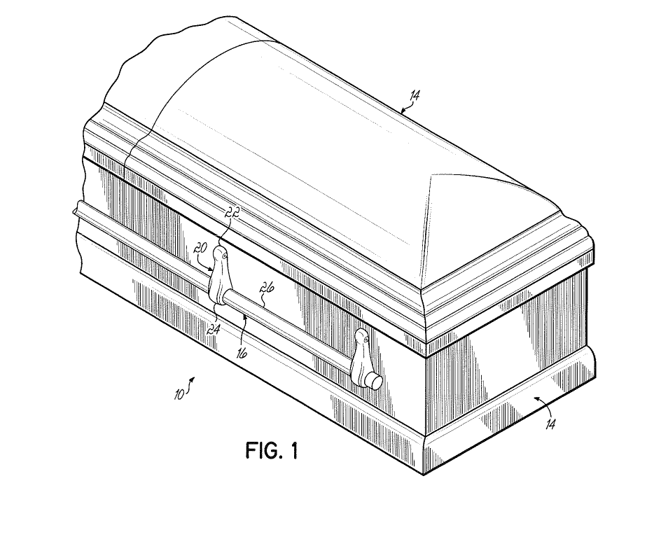

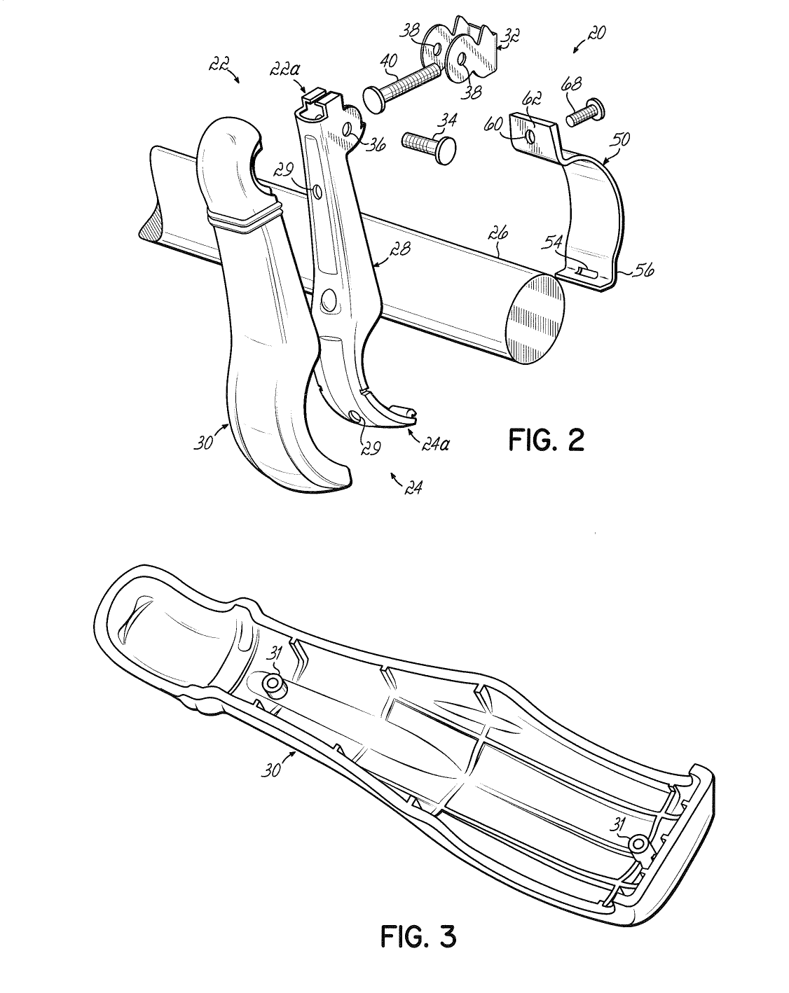

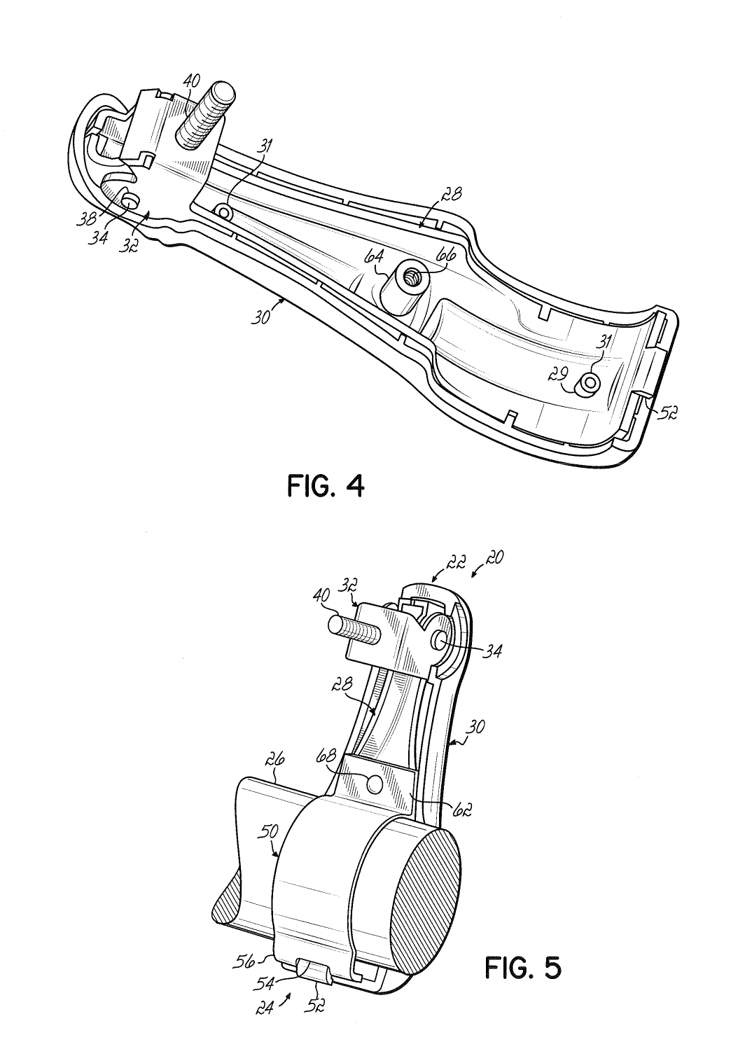

Referring first to FIG. 1, a casket 10 has a shell 12, at least one lid 14 closeable on the shell 12, and hardware 16 attached to the shell 12.

Referring to all the Figs., the casket hardware 16 comprises an arm 20 having first 22 and second 24 ends, the first end 22 attached to the shell. A handle bar 26 is attached to the second end 24. The arm 20 has a first structural load carrying portion 28 for transmitting loads between the handle bar 26 and the shell 12, and a second nonstructural decorative portion 30 overlying the first portion 28.

The second portion 30 of the arm 20 can be permanently or removably secured to the first portion 28 of the arm 20. An example of the second portion 30 being removably secured to the first portion 28 is to make the second portion 30 a snap fit onto the first portion 28. For example, first portion 28 can include a pair of holes 29, and second portion 30 an include a pair of bosses 31 which are received in the holes 29 in a snap fit fashion. The first portion 28 of the arm 20 can be fabricated of, for example, steel and the second portion 30 of the arm 20 can be fabricated of, for example, plastic. Other suitable materials can of course be used for the first 28 and second 30 portions of the arm 20.

The first end 22 of the arm 20 can be attached to the shell 12 via a clevis 32. More particularly, the first end 22 of the arm 20 can be pivotally secured to the clevis 32 by a bolt, screw, pin, rivet, or equivalent 34 which passes through holes 36 in the first end 22a of the first portion 28 of the arm 20 and through holes 38 in the clevis 32. The clevis 32 can be fixedly secured to the shell 12 as by a bolt, screw, pin, rivet, or equivalent 40.

The arm 20 can include a third portion 50 which cooperates with the first portion 28 to attach the handle bar 26 to the arm 20. The first 28 and third 50 portions of the arm 20 can be shaped to conform to the shape of the handle bar 26. The first portion 28 of the arm 20 can include a tongue 52 on a lower end 24a thereof, and the third portion 50 of the arm 20 can include a slot 54 in a lower end 56 thereof. The tongue 52 fits in the slot 54. The third portion 50 can include a hole 60 in an upper end 62 thereof, and the first portion 28 can include a boss 64 having an internally threaded hole 66 therein. A bolt or screw 68 can be passed through hole 60 and threaded into internally threaded hole 66. Boss 64 can be integrally formed as a part of a unitary first portion 28 of arm 20, or it can be, for example, a separate piece pressed into a hole in the first portion 28 from a front side thereof which is then peened to prevent it from pulling through the hole in the first portion 28 when bolt 68 is tightened.

The embodiments shown and described are merely for illustrative purposes only. The drawings and the description are not intended to limit in any way the scope of the claims. Those skilled in the art will appreciate various other changes, modifications, and embodiments. All such changes, modifications and embodiments are deemed to be embraced by the claims. Accordingly, the scope of the right to exclude shall be limited only by the following claims and their equivalents.

What is claimed is:

1. a casket comprising:
a casket shell,
a casket lid closeable on said shell, and
casket hardware comprising:
an arm having a first end and a second end, said first end attached to said shell,
a handle bar attached to said second end, and
said arm having a first structural load carrying portion for transmitting loads between said handle bar and said shell, and a second nonstructural decorative portion overlying said first portion.

2. The casket of claim 1 wherein said second portion of said arm is permanently secured to said first portion of said arm.

3. The casket of claim 1 wherein said second portion of said arm is removably secured to said first portion of said arm.

4. The casket of claim 3 wherein said first portion of said arm is fabricated of steel and said second portion of said arm is fabricated of plastic.

5. The casket of claim 4 wherein said second portion of said arm is a snap fit onto said first portion of said arm.

6. The casket of claim 1 wherein said first end of said arm is attached to said shell via a clevis.

7. The casket of claim 6 wherein said first end of said arm is pivotally secured to said clevis and said clevis is fixedly secured to said shell.

8. The casket of claim 1 wherein said arm includes a third portion which cooperates with said first portion to attach said handle bar to said arm.

9. The casket of claim 8 wherein said first and third portions of said arm are shaped to conform to the shape of said handle bar.

10. The casket of claim 8 wherein said first portion of said arm includes a tongue on a lower end thereof, and said third portion of said arm includes a slot in a lower end thereof, said tongue fitting in said slot.

11. The casket of claim 10 wherein said first portion of said arm includes a boss with an internally threaded hole therein, said third portion of said arm includes a hole in an upper end thereof, and a bolt is passed through said hole in said third portion and is threaded into said internally threaded hole in said boss in said first portion.

12. Casket hardware comprising:
an arm having a first end and a second end, said first end adapted to be attached to a shell of a casket,
a handle bar attached to said second end, and
said arm having a first structural load carrying portion for transmitting loads between said handle bar and the shell, and a second nonstructural decorative portion overlying said first portion.

13. The casket hardware of claim 12 wherein said second portion of said arm is permanently secured to said first portion of said arm.

14. The casket hardware of claim 12 wherein said second portion of said arm is removably secured to said first portion of said arm.

15. The casket hardware of claim 14 wherein said first portion of said arm is fabricated of steel and said second portion of said arm is fabricated of plastic.

16. The casket hardware of claim 15 wherein said second portion of said arm is a snap fit onto said first portion of said arm.

17. The casket hardware of claim 12 wherein said first end of said arm is adapted to be attached to the shell via a clevis.

18. The casket hardware of claim 17 wherein said first end of said arm is pivotally secured to said clevis and said clevis is adapted to be fixedly secured to the shell.

19. The casket hardware of claim 12 wherein said arm includes a third portion which cooperates with said first portion to attach said handle bar to said arm.

20. The casket hardware of claim 19 wherein said first and third portions of said arm are shaped to conform to the shape of said handle bar.

21. The casket hardware of claim 19 wherein said first portion of said arm includes a tongue on a lower end thereof, and said third portion of said arm includes a slot in a lower end thereof, said tongue fitting in said slot.

22. The casket hardware of claim 21 wherein said first portion of said arm includes a boss with an internally threaded hole therein, said third portion of said arm includes a hole in an upper end thereof, and a bolt is passed through said hole in said third portion and is threaded into said internally threaded hole in said boss in said first portion.
